(19) United States
(12) Patent Application Publication
(10) Pub. No.: US 2010/0132506 A1
(43) Pub. Date: Jun. 3, 2010

(54) FEED DRIVE MECHANISM AND FLEXIBLE CONNECTION PLATE THEREOF

(75) Inventors: Shih-Chang CHEN, Hsinchu County (TW); Tzuo-Liang Luo, Hsinchu City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 12/359,469

(22) Filed: Jan. 26, 2009

(30) Foreign Application Priority Data
Dec. 3, 2008 (TW) 097147021

(51) Int. Cl. F16H 35/06; F16M 1/00

(52) U.S. Cl. 74/841; 267/137

(57) ABSTRACT

A flexible connection plate is used in a feed drive mechanism. The flexible connection plate has a first portion, a second portion joined to the first portion, and a plurality of elastic grooves between the first portion and the second portion. The first portion and the second portion are fixed to a nut seat and a lead screw nut of the feed drive mechanism respectively. The elastic grooves are axially penetrating the connection plate. Adjacent elastic grooves have an overlapping section respectively, such that the flexible connection plate has a characteristic of elastic deformation in a radial direction, so as to absorb errors resulted from assembly, and improve non-parallelism resulted from the assembly errors, thereby increasing the feed accuracy of the feed drive mechanism. Furthermore, the rigidity of the flexible connection plate in an axial direction is high enough to drive the feed drive mechanism to be positioned precisely.

### CROSS-REFERENCE TO RELATED APPLICATIONS

This non-provisional application claims priority under 35 U.S.C. § 119(a) on Patent Application No(s). 097147021 filed in Taiwan, R.O.C. on Dec. 3, 2008 the entire contents of which are hereby incorporated by reference.

### BACKGROUND OF THE INVENTION

1. Field of Invention

The present invention relates to a feed drive mechanism, and more particularly relates to a feed drive mechanism having a flexible connection plate.

2. Related Art

Relevant products in various industries such as the current semiconductor industry, panel industry, and biochip industry have been developed in the trend of light, thin, short, and small, for example, the product feature micro orifices, micro grooves, V-shaped grooves, and irregular holes, which have a size between several micrometers (μm) to hundreds of micrometers (μm). Therefore, a feed mechanism of a machine fabricating these products must have higher accuracy to meet the demand for super fine processing. However, only several tens of thousands of median machine tools are used domestically each year to provide a micro infeed of from 1 μm to 2 μm, which is far from sufficient to meet the demand of the fine processing industry for mass production at present.

FIGS. 1 and 2 are schematic views of a feed drive mechanism of the conventional art. A conventional feed drive mechanism 10 is mounted on a processing machinery frame 20. Two guide rails 21 are disposed on the processing machinery frame 20 separately, and a moving table 22 connected to the feed drive mechanism 10 is also disposed on the processing machinery frame 20. The moving table 22 is movably disposed on the guide rails 21, and can move with respect to the processing machinery frame 20 reciprocally.

Referring to FIGS. 1 and 2 again, the conventional feed drive mechanism 10 includes a bearing tailstock 11, a lead screw 12, a nut seat 13, a lead screw nut 14, a connection plate 15, and a motor mount 16. The bearing tailstock 11 is fixed on the processing machinery frame 20, an end of the lead screw 12 is disposed on the bearing tailstock 11, and the other end is connected to the motor mount 16. The lead screw 12 is disposed in a direction parallel to the guide rails 21. The nut seat 13 is sleeved on the lead screw 12, and is combined with the moving table 22. The lead screw nut 14 is disposed in the nut seat 13, and is sleeved on the lead screw 12. An end of the lead screw nut 14 protrudes from the nut seat 13. The connection plate 15 is sleeved on the lead screw 12, and is fixed in combination with the nut seat 13 and the lead screw nut 14. When the lead screw 12 is driven to rotate by the motor mount 16, the nut seat 13 and the moving table 22 will be drive to move reciprocally towards a direction parallel to the guide rails 21, so as to achieve the function for positioning precisely.

Errors in the assembling accuracy often occur when the conventional feed drive mechanism is assembled, for example, micro infeed stick-slip because the lead screw and the guide rail are not in parallel, assembly error caused by the sag of the lead screw when it is too long. The errors will cause that the positioning accuracy of the feed drive mechanism is not ideal, thereby affecting the accuracy in the processing size significantly. However, the problem of the processing machine cannot be solved by using the parts of the conventional feed drive mechanism, because the connection plate is configured to improve the fitting between the lead screw nut and the nut seat, instead of improving the accuracy of the processing machine and eliminating the feed errors.

### SUMMARY OF THE INVENTION

The present invention is directed to a feed drive mechanism and a flexible connection thereof, which solve the problems of the conventional feed drive mechanism, such as sag of a lead screw caused by a self-weight of the lead screw, imperfect parallelism and micro-feed stick-slip resulted from errors in assembling accuracy.

The feed drive mechanism of the present invention includes a nut seat, a lead screw nut, and a flexible connection plate. The flexible connection plate has a first portion, a second portion, and a plurality of elastic grooves that are separated from one another. The first portion and the second portion are joined in a radial direction, while the first portion is axially fixed on the nut seat, and the second portion is axially fixed on the lead screw nut. The elastic grooves are configured between the first portion and the second portion, and axially penetrate through the connection plate. An end of each of two adjacent elastic grooves has an overlapping section, such that the flexible connection plate has a characteristic of elastic deformation in a radial direction.

The effect of the present invention is as follows. The flexible connection plate is designed to have the elastic grooves penetrating the flexible connection plate, and an end of each of two adjacent elastic grooves overlaps each other, such that the flexible connection plate has the characteristic of elastic deformation in a radial direction. Thus, the imperfect parallelism resulted from the assembling errors is improved, thereby increasing the feed accuracy of the feed drive mechanism. Further, the flexible connection plate is still highly rigid in an axial direction for driving the feed drive mechanism.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a feed drive mechanism of the conventional art;

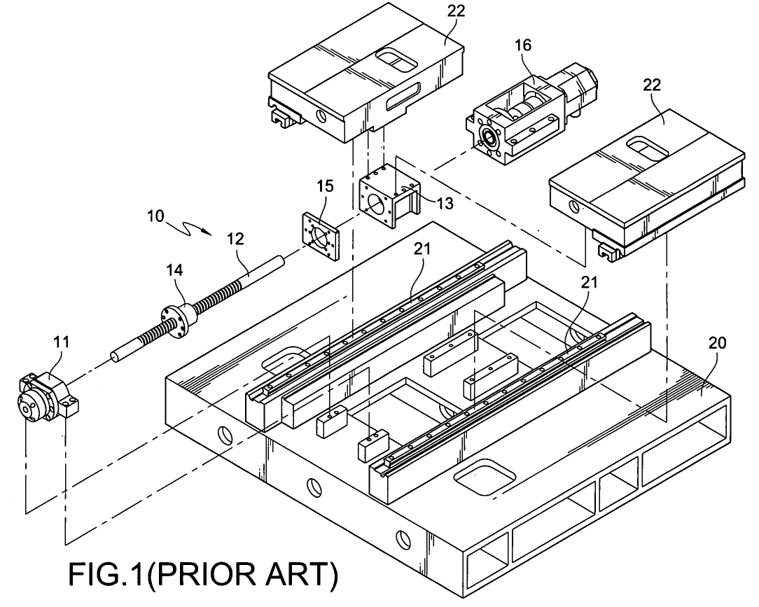

FIG. 2 is a schematic view of the feed drive mechanism of the conventional art;

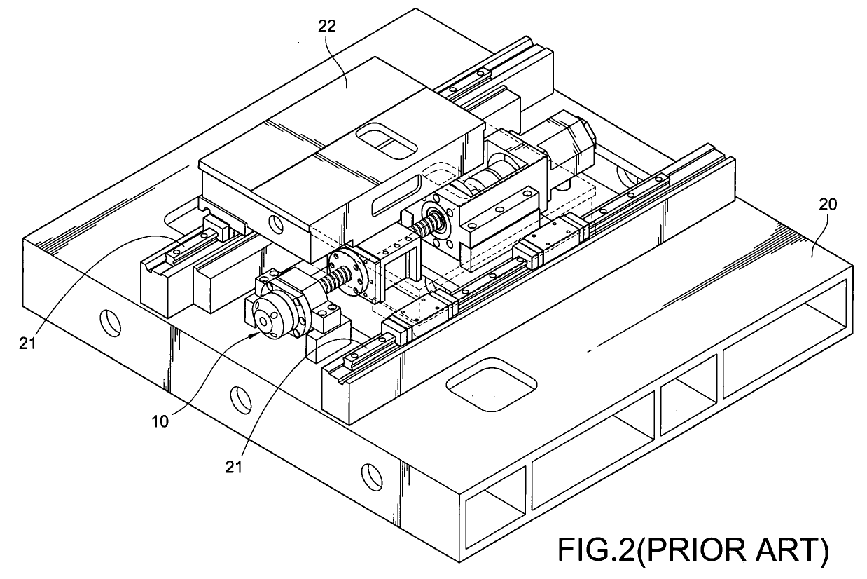

FIG. 3 is a schematic view of a flexible connection plate of the present invention;

FIG. 4 is an enlarged view of a part of an elastic groove of the flexible connection plate of the present invention;

FIG. 5 is an exploded view of the feed drive mechanism of the present invention;

FIG. 6 is a schematic view of the present invention;

FIG. 7 is an enlarged view of a part of the elastic groove in a different configuration of the present invention;

FIG. 8 is an enlarged view of a part of the elastic groove in a different configuration of the present invention;

FIG. 9 is a schematic view of a simulation and analysis of the rigidity of the flexible connection plate in a Z direction of the present invention;

FIG. 10 is a schematic view of a simulation and analysis of the rigidity of the flexible connection plate in an X direction of the present invention; and

FIG. 11 is a schematic view of a simulation and analysis of the rigidity of the flexible connection plate in a Y direction of the present invention.

### DETAILED DESCRIPTION OF THE INVENTION

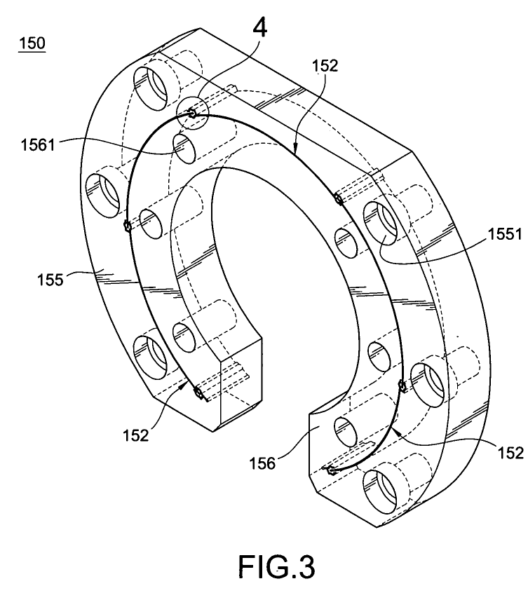

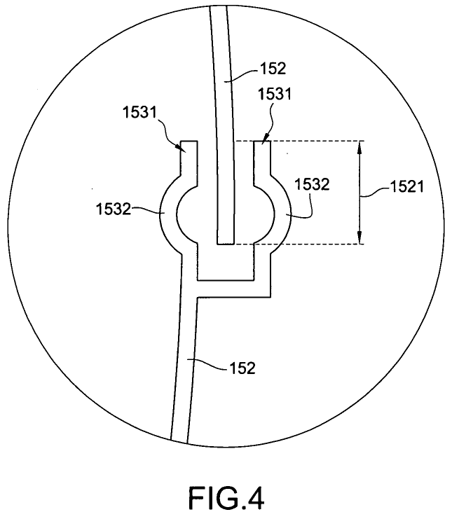

Referring to FIGS. 3 and 4, a flexible connection plate 150 of the present invention has a plurality of elastic grooves 152 axially penetrating it, and the elastic grooves 152 divide the flexible connection plate 150 into a first portion 155 at an outer edge and a second portion 156 at an inner edge, such that the elastic grooves 152 are disposed between the first portion 155 and the second portion 156. The elastic grooves 152 are separated from one another, such that the first portion 155 and the second portion 156 are joined to each other. The elastic grooves 152 are arranged symmetrically around the center of the flexible connection plate 150 to form a ring-shaped linear structure in series.

An end of the two adjacent elastic grooves 152 has an overlapping section 1521. The overlapping section 1521 of one of the adjacent elastic grooves 152 further has opposite two resilient arms 1531, which are joined to each other. The two resilient arms 1531 are spaced at an interval. The overlapping section 1521 of the other one of the adjacent elastic grooves 152 is disposed between the two resilient arms 1531 to form a hinge. The two resilient arms 1531 further have an arc segment 1532 respectively, such that the resilient arms 1531 may absorb the shock energy. Through the structure of the elastic grooves 152, the overall structure of the flexible connection plate 150 has a characteristic of elastic deformation in a radial direction.

It should be noted that the elastic grooves 152 are formed through a wire electrical discharge machining (WEDM) process, while the structural design of the groove width of the elastic grooves 152 and the overlapping section 1521 of the two adjacent elastic grooves 152 can absorb the deformation resulted from the assembling errors. Moreover, the minimum number of the hinge formed by the resilient arms 1531 and the elastic grooves 152 for enabling the flexible connection plate 150 to elastically deform in the radial direction is only one; however, the size, number, and position of the hinge can be adjusted correspondingly, depending on the actual application state and demand. Further, the elastic grooves 152 and the hinge structure are not limited to the description in this embodiment, that is, are not limited to being disposed symmetrically around the center of the flexible connection plate 150.

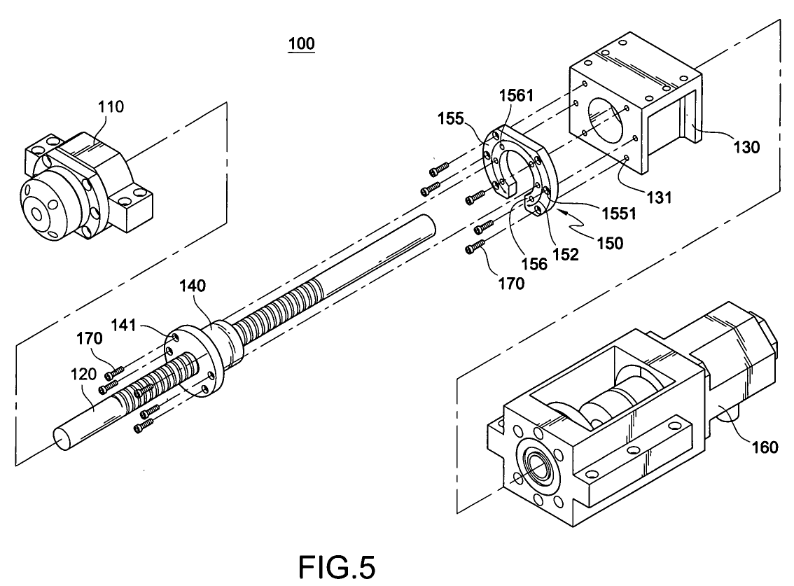

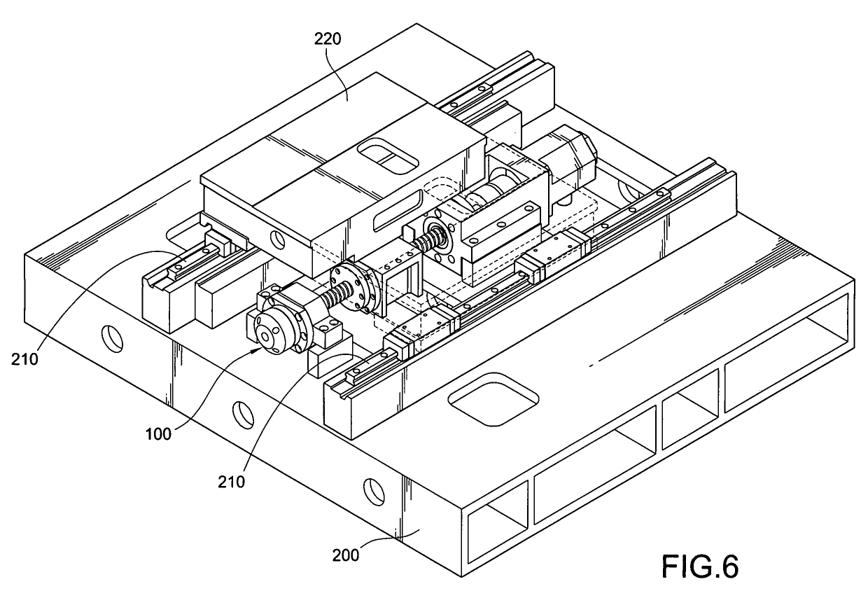

Referring to the exploded views of FIGS. 5 and 6, the feed drive mechanism 100 is mounted on a base 200, which may be a saddle for an integrated machinery processing machine. The base 200 has guide rails 210 adjacent to the feed drive mechanism 100, and a moving table 220 connected with the feed drive mechanism 100. The moving table 220 is movably disposed on the guide rails 210, and can move reciprocally with respect to the base 200.

As shown in FIGS. 5 and 6, the feed drive mechanism 100 of the present invention includes a bearing tailstock 110, a lead screw 120, a nut seat 130, a lead screw nut 140, a flexible connection plate 150, and a motor mount 160. The bearing tailstock 110 is fixed on the base 200, an end of the lead screw 120 is disposed on the bearing tailstock 110, and the other end of the lead screw 120 is connected to the motor mount 160. The lead screw 120 is disposed in a direction parallel to a movement direction of the moving table 220. The nut seat 130 is movably sleeved on the lead screw 120, and the nut seat 130 is combined with the moving table 220. The lead screw nut 140 is disposed in the nut seat 130, and is movably sleeved on the lead screw 120. An end of the lead screw nut 140 protrudes from the nut seat 130. The flexible connection plate 150 sleeves on the lead screw 120, and two connection surfaces 151 of the flexible connection plate 150 are attached to the nut seat 130 and the lead screw nut 140.

Still referring to FIGS. 5 and 6, the first portion 155 of the flexible connection plate 150 defined by the elastic grooves 152 has a plurality of first fixing holes (counter bores) 1551, the nut seat 130 has a plurality first combining holes (screw holes) 131 corresponding to the first fixing holes (counter bores) 1551, and a plurality of locking elements 170, for example bolts, penetrates the first fixing holes (counter bores) 1551 respectively and locks to the first combining holes (screw holes) 131, such that the flexible connection plate 150 is axially fixed on the nut seat 130. The second portion 156 of the flexible connection plate 150 defined by the elastic grooves 152 has a plurality of second fixing holes (screw holes) 1561, the lead screw nut 140 has a plurality of second combining holes 141 corresponding to the second fixing holes (screw holes) 1561, and the plurality of locking elements 170, for example bolts, penetrates the second fixing holes 1561 respectively and locks to the second combining holes 141, such that the lead screw nut 140 is axially fixed on the flexible connection plate 150.

Notably, the combining means of the present invention is as follows. The first portion 155 on a side of the flexible connection plate 150 is combined with the nut seat 130, and the second portion 156 on the other side of the flexible connection plate 150 is combined with the lead screw nut 140. Through the combining means, the flexible connection plate 150 is axially fixed between the nut seat 130 and the lead screw nut 140. Persons skilled in the art may fix the flexible connection plate 150 to the nut seat 130 and the lead screw nut 140 through other combining means designs, which are not limited to the embodiment of the present invention.

The thickness of the flexible connection plate 150 of the present invention is about tens of millimeters (mm). Therefore, it can be installed in any type of the lead screw feed mechanism, and is not limited to the feed drive mechanism 100 of the present invention.

Referring to FIGS. 5 and 6, when the motor mount 160 is driven, the lead screw 120 is driven to rotate in a rotating direction, and the nut seat 130 and the moving table 220 are driven to move reciprocally in an axial direction of the lead screw 120 (that is, in parallel with the direction of the guide rails 210). During the movement of the nut seat 130 and the moving table 220, the flexible connection plate 150 attached to the nut seat 130 has the ability of elastic deformation in the radial direction through the elastic grooves 152. In details, through the overlapping sections 1521 that are arranged evenly of the elastic grooves 152, when the lead screw 120 moves reciprocally, the feed drive mechanism 100 enables the hinge formed by the two resilient arms 1521 of an elastic groove 152 and the overlapping section 1521 of the other adjacent elastic groove 152 to deform elastically. As the elastic grooves 152 axially penetrate the flexible connection plate 150, the rigidity of the flexible connection plate 150 in an axial direction is maintained to some extent, which is high enough to drive the displacement of the feed drive mechanism 100 but will not cause deformation.

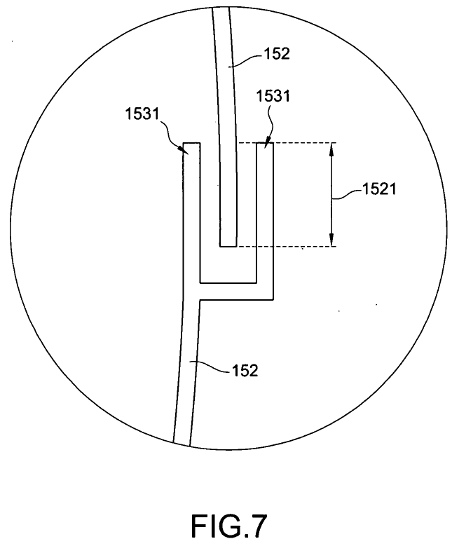

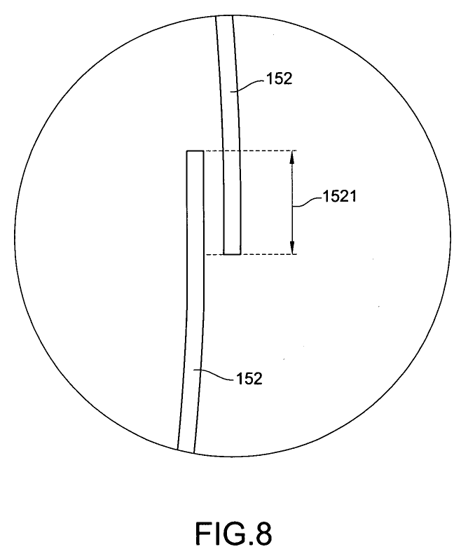

FIGS. 7 and 8 are the enlarged views of a part of the elastic grooves in different configurations of the flexible connection plate of the present invention.

As shown in FIG. 7, the overlapping section 1521 of one of the adjacent elastic grooves 152 has two opposite resilient arms 1531, which are joined to each other. The two resilient arms 1531 are disposed in parallel, and are spaced at an interval. The overlapping section 1521 of the other one of the adjacent elastic grooves 152 is disposed between the two resilient arms 1531 to form a hinge. The configuration of the resilient arms 1531 shown in FIG. 7 is not designed to include an arc segment (as shown in FIG. 4), but the overall structure of the flexible connection plate 150 still has the characteristic of elastic deformation in a radial direction.

As shown in FIG. 8, the overlapping sections 1521 of the two adjacent elastic grooves 152 of the present invention overlap each other, and no resilient arm or arc segment is formed at the overlapping sections 1521 of one of the elastic grooves 152 (as shown in FIG. 4). However, the flexible connection plate 150 still has the characteristic of elastic deformation in a radial direction through the overlapping sections 1521 of the elastic grooves 152. The elastic grooves 152 of the present invention can be further designed to have various configurations that are overlapping one another, and are not limited to the abovementioned configurations disclosed in the present invention.

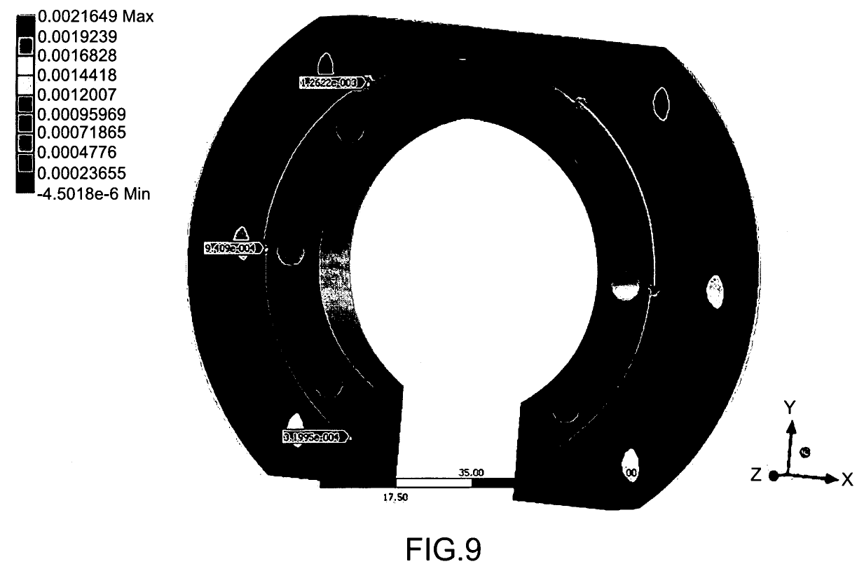

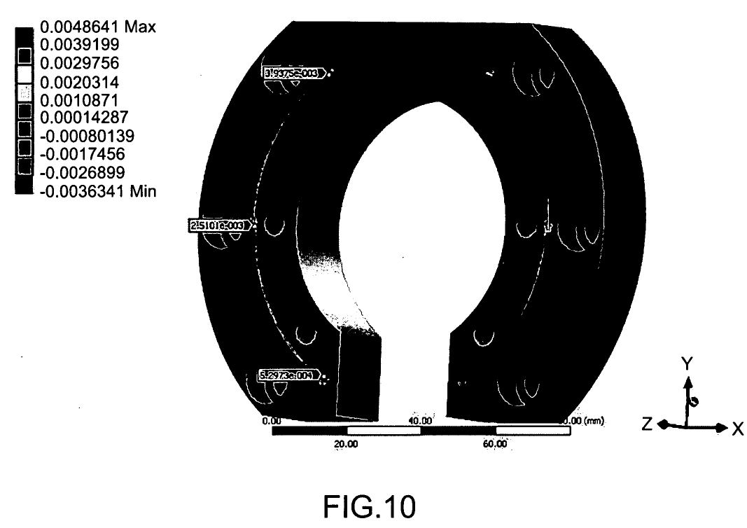

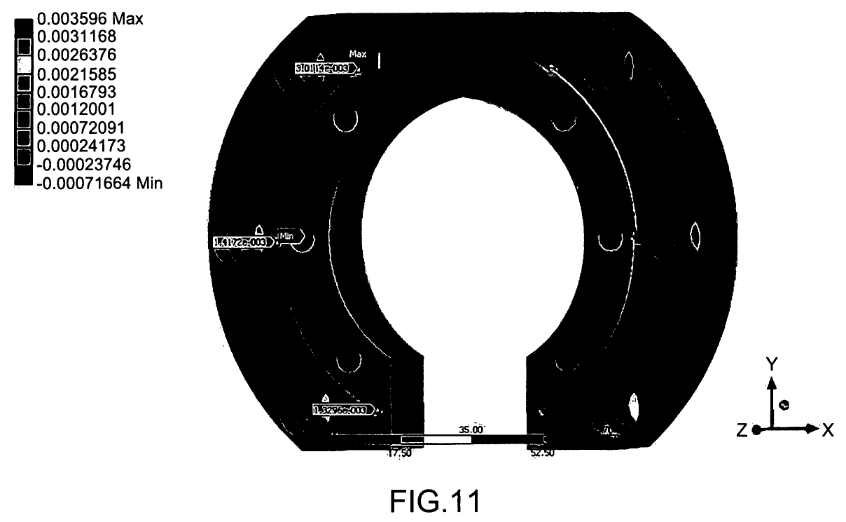

FIGS. 9 to 11 are schematic views of a simulation and analysis of rigidity of the flexible connection plate of the present invention. As shown in the figures, the flexible connection plate of the present invention has a strength of 79.36 kilogram/micrometer (kg/μm) in an axial direction (the Z direction in the figures), and a strength of 25.64 kilogram/micrometer and a strength of 33.33 kilogram/micrometer in the radial direction (the X and Y directions in the figures) respectively. The rigidity of the flexible connection plate in the radial direction is smaller than the rigid strength in the axial direction. Therefore, through the design of the elastic grooves of the present invention, the flexible connection plate has better ability of elastic deformation in the radial direction.

The flexible connection plate of the present invention has the through elastic grooves. Through the hinge formed by the overlapping sections on the ends of two adjacent elastic grooves, the flexible connection plate can deform elastically in a radial direction. The flexible connection plate is fixed between the nut seat and the lead screw nut of the feed drive mechanism and is attached to them, and the fitting of the nut seat and the lead screw nut can be modified. Thus, the non-parallelism resulted from the assembly errors of the feed drive mechanism is effectively improved, and the problems of micro-feed stick-slip and sag caused by the weight of the lead screw are prevented, thereby increasing the feed accuracy of the feed drive mechanism. The flexible connection plate still has enough rigidity in an axial direction to bear the stress produced by the feed drive mechanism when the mechanism is driven.

Furthermore, it is easy to process the elastic grooves of the flexible connection plate, so the manufacturing cost is low, and the processing accuracy of the machinery processing machine using the flexible connection plate of the present invention is increased significantly, such that the value and yield for the machinery processing machine are further improved.

What is claimed is:

1. A flexible connection plate, applied in a feed drive mechanism, wherein the feed drive mechanism has a nut set and a lead screw nut, the flexible connection plate comprising:
a first portion, fixed to the nut set;
a second portion, joined to the first portion in a radial direction, and fixed on the lead screw nut; and
a plurality of elastic grooves, configured between the first portion and the second portion, and axially penetrating the connection plate, wherein the adjacent elastic grooves have an overlapping section.

2. The flexible connection plate according to claim 1, wherein the overlapping section of one of the adjacent elastic grooves further comprises two opposite resilient arms, and the overlapping section of the other one of the adjacent elastic grooves is disposed between the two resilient arms.

3. The flexible connection plate according to claim 1, wherein the two resilient arms further comprise an arc segment respectively.

4. The flexible connection plate according to claim 1, wherein the first portion has a plurality of first fixing holes, the nut seat has a plurality of first combining holes corresponding to the first fixing holes, and the flexible connection plate is mounted on the nut seat by passing a plurality of locking elements through the first fixing holes and locking to the first combining holes; the second portion has a plurality of second fixing holes, the lead screw nut has a plurality of second combining holes corresponding to the second fixing holes, and the lead screw nut is mounted on the flexible connection plate by passing the plurality of locking elements through the second fixing holes and locking to the second combining holes.

5. The flexible connection plate according to claim 1, wherein the elastic grooves are separated from one another, such that the first portion and the second portion are joined to each other.

6. The flexible connection plate according to claim 1, wherein the elastic grooves are arranged in series to form a ring-shaped linear structure.

7. A feed drive mechanism, comprising:
a bearing tailstock;
a lead screw, having an end disposed on the bearing tailstock;
a nut seat, movably sleeved on the lead screw;
a lead screw nut, disposed in the nut seat and movably sleeved on the lead screw, wherein an end of the lead screw nut protrudes from the nut seat;
a motor seat, connected to the other end of the lead screw for driving the lead screw to rotate and driving the nut seat to move reciprocally; and
a flexible connection plate, comprising:
a first portion, fixed to the nut set;
a second portion, joined to the first portion in a radial direction, and fixed to the lead screw nut; and
a plurality of elastic grooves, configured between the first portion and the second portion, and axially penetrating the connection plate, wherein the adjacent elastic grooves have an overlapping section.

8. The feed drive mechanism according to claim 7, wherein the overlapping section of one of the adjacent elastic grooves further comprises two opposite resilient arms, and the overlapping section of the other one of the adjacent elastic grooves is disposed between the two resilient arms.

9. The feed drive mechanism according to claim 7, wherein the two resilient arms further comprise an arc segment respectively.

10. The feed drive mechanism according to claim 7, wherein the first portion has a plurality of first fixing holes, the nut seat has a plurality of first combining holes corresponding to the first fixing holes, and the flexible connection plate is mounted on the nut seat by passing a plurality of locking elements through the first fixing holes and locking to the first combining holes; the second portion has a plurality of second fixing holes, the lead screw nut has a plurality of second combining holes corresponding to the second fixing holes, and the lead screw nut is mounted on the flexible connection plate by passing the plurality of locking elements through the second fixing holes and locking to the second combining holes.

11. The feed drive mechanism according to claim 7, wherein the elastic grooves are separated from one another, such that the first portion and the second portion are joined to each other.

12. The feed drive mechanism according to claim 7, wherein the elastic grooves are arranged in series to form a ring-shaped linear structure.
